(19) United States
(12) Patent Application Publication
(10) Pub. No.: US 2023/0216076 A1
(43) Pub. Date: Jul. 6, 2023

(54) COMPLIANT RODS FOR FUEL CELL

(71) Applicant: Hamilton Sundstrand Corporation, Charlotte, NC (US)

(72) Inventors: Andrzej Ernest Kuczek, Bristol, CT (US); Robert Mason Darling, South Windsor, CT (US); Kristoffer Ridgeway, Simsbury, CT (US); Timothy Davenport, South Windsor, CT (US)

(21) Appl. No.: 17/570,080

(22) Filed: Jan. 6, 2022

(51) Int. Cl. H01M 8/248

(52) U.S. Cl. CPC H01M 8/248

(57) ABSTRACT

A fuel cell assembly including a fuel cell stack having a first stack end and a second stack end, a first end plate located at the first stack end, and a second end plate located at the second stack end. The fuel cell stack being interposed between the first end plate and the second end plate. The fuel cell assembly including a compliant assembly extending from a first end to a second end located opposite the first end. The compliant assembly is configured to anchor together the fuel cell stack, the first end plate, and the second end plate. The compliant assembly include a rod extending from a first rod end to a second rod end. The compliant assembly also includes a connector body secured to the rod at or proximate the first rod end and an anchoring mechanism secured to the connector body.

### BACKGROUND

The embodiments herein generally relate to fuel cell stack assemblies that are suited for usage in transportation vehicles, portable power plants, or as stationary power plant and more specifically to compliant rods for a fuel cell.

Fuel cells are well-known and are commonly used to produce electrical energy from reducing and oxidizing reactant fluids to power electrical apparatuses such as apparatus on-board space vehicles, transportation vehicles, or as on-site generators for buildings. A plurality of planar fuel cell plate components are typically arranged into a fuel cell stack surrounded by a frame structure. Each individual fuel cell generally includes an anode electrode and a cathode electrode separated by an electrolyte. A reducing fluid such as hydrogen is supplied to the anode electrode, and an oxidant such as oxygen or air is supplied to the cathode electrode. In a cell utilizing a proton exchange membrane (“PEM”) as the electrolyte, the hydrogen electrochemically reacts at a catalyst surface of the anode electrode to produce hydrogen ions and electrons. The electrons are conducted to an external load circuit and then returned to the cathode electrode, while the hydrogen ions transfer through the electrolyte to the cathode electrode, where they react with the oxidant and electrons to produce water and release thermal energy.

### BRIEF SUMMARY

According to one embodiment, a fuel cell assembly is provided. The fuel cell assembly including a fuel cell stack having a first stack end and a second stack end located opposite the first stack end, a first end plate located at the first stack end, and a second end plate located at the second stack end. The fuel cell stack being interposed between the first end plate and the second end plate. The fuel cell assembly including a compliant assembly extending from a first end to a second end located opposite the first end. The first end being located proximate or at the first end plate and the second end being located proximate or at the second end plate. The compliant assembly is configured to anchor together the fuel cell stack, the first end plate, and the second end plate. The compliant assembly include a rod extending from a first rod end to a second rod end located opposite the first rod end. The first rod end being located proximate or at the first stack end and the second rod end being located proximate or at the second stack end. The compliant assembly also includes a connector body secured to the rod at or proximate the first rod end and an anchoring mechanism secured to the connector body, the anchoring mechanism being configured to anchor the first end plate to the fuel cell stack.

In addition to one or more of the features described above, or as an alternative, further embodiments may include that the rod is configured to expand with expansion of the fuel cell stack and contract with contraction of the fuel cell stack.

In addition to one or more of the features described above, or as an alternative, further embodiments may include that the rod is composed of a compliant material that is configured to expand with expansion of the fuel cell stack and contract with contraction of the fuel cell stack.

In addition to one or more of the features described above, or as an alternative, further embodiments may include that the rod is composed of a composite material that includes a plurality of composite fibers.

In addition to one or more of the features described above, or as an alternative, further embodiments may include that the plurality of composite fibers have a braiding angle that is non-perpendicular and non-parallel to a central longitudinal axis of the rod.

In addition to one or more of the features described above, or as an alternative, further embodiments may include that the rod has a passageway formed therein. The connector body is secured to the passageway of the rod.

In addition to one or more of the features described above, or as an alternative, further embodiments may include that the first end plate further includes an inward side, an outward side located opposite the inward side, and a through-passage extending completely through the first end plate from the inward side to the outward side. The connector body extends through the through-passage of the first end plate.

In addition to one or more of the features described above, or as an alternative, further embodiments may include that the connector body further includes a first connector end, a second connector end located opposite the first connector end, and external threads located at or proximate the first connector end. The anchoring mechanism is a nut having internal threads configured to interlock with the external threads of the connector body, the nut being located proximate the outward side of the first end plate.

In addition to one or more of the features described above, or as an alternative, further embodiments may include that the connector body further includes an anti-rotation mechanism configured to prevent rotation of the connector body relative to the first end plate.

In addition to one or more of the features described above, or as an alternative, further embodiments may include that the anti-rotation mechanism is configured to prevent rotation of the connector body relative to the first end plate by interlocking with the first end plate.

In addition to one or more of the features described above, or as an alternative, further embodiments may include that the anti-rotation mechanism is a flange extending away from the connector body. The through-passage further includes a slot extending radially outward from the through-passage and into the first end plate. The flange is configured to interlock with the slot.

In addition to one or more of the features described above, or as an alternative, further embodiments may include that the slot is located at the inward side of the first end plate and extends into the first end plate.

In addition to one or more of the features described above, or as an alternative, further embodiments may include that the compliant assembly includes: a second connector body secured to the rod at or proximate the second rod end and a second anchoring mechanism secured to the second connector body. The second anchoring mechanism being configured to anchor the second end plate to the fuel cell stack.

According to another embodiment, a method of manufacturing a fuel cell assembly is provided. The method includes locating a first end plate adjacent to a first stack end of a fuel cell stack and locating a second end plate adjacent to a second stack end of the fuel cell stack opposite the first stack end. The fuel cell stack being interposed between the first end plate and the second end plate. The method also includes anchoring together the fuel cell stack, the first end plate, and the second end plate using a compliant assembly. The compliant assembly extending from a first end to a second end located opposite the first end. The first end is located proximate or at the first end plate and the second end being located proximate or at the second end plate. The compliant assembly includes a rod extending from a first rod end to a second rod end located opposite the first rod end. The first rod end being located proximate or at the first stack end and the second rod end being located proximate or at the second stack end. The compliant assembly also includes a connector body secured to the rod at or proximate the first rod end and an anchoring mechanism secured to the connector body. The anchoring mechanism being configured to anchor the first end plate to the fuel cell stack.

In addition to one or more of the features described above, or as an alternative, further embodiments may include securing the connector body to the rod, the connector body including a first connector end and a second connector end located opposite the first connector end. The connector body is secured to the rod at or proximate the second connector end of the connector body.

In addition to one or more of the features described above, or as an alternative, further embodiments may include sliding the first end plate onto the connector body such that the first connector end of the connector body is inserted through a through-passage of the first end plate.

In addition to one or more of the features described above, or as an alternative, further embodiments may include rotating a nut onto external threads of the connector body located at or proximate the first connector end of the connector body. The nut including internal threads configured to interlock with the external threads of the connector body.

In addition to one or more of the features described above, or as an alternative, further embodiments may include aligning a flange of the connector body with a slot of the through-passage of the first end plate. The flange being configured to interlock with the slot to prevent rotation of the connector body relative to the first end plate.

In addition to one or more of the features described above, or as an alternative, further embodiments may include forming the rod from a composite material. The composite material including a plurality of composite fibers having a braiding angle that is non-perpendicular and non-parallel to a central longitudinal axis of the rod.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

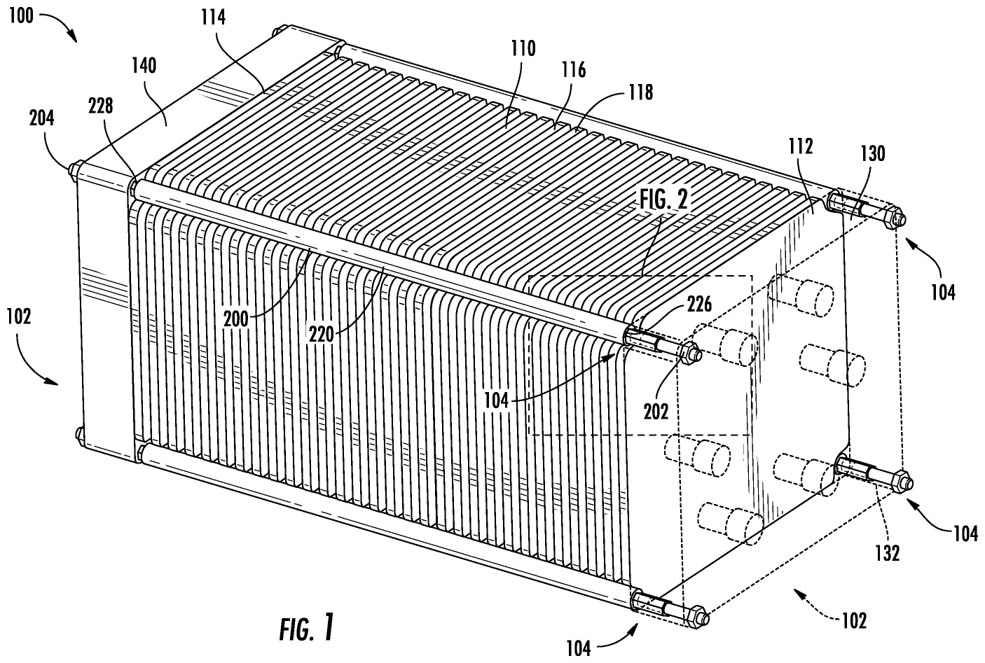

FIG. 1 is a schematic illustration of a fuel cell assembly with a compliant assembly, according to an embodiment of the present disclosure;

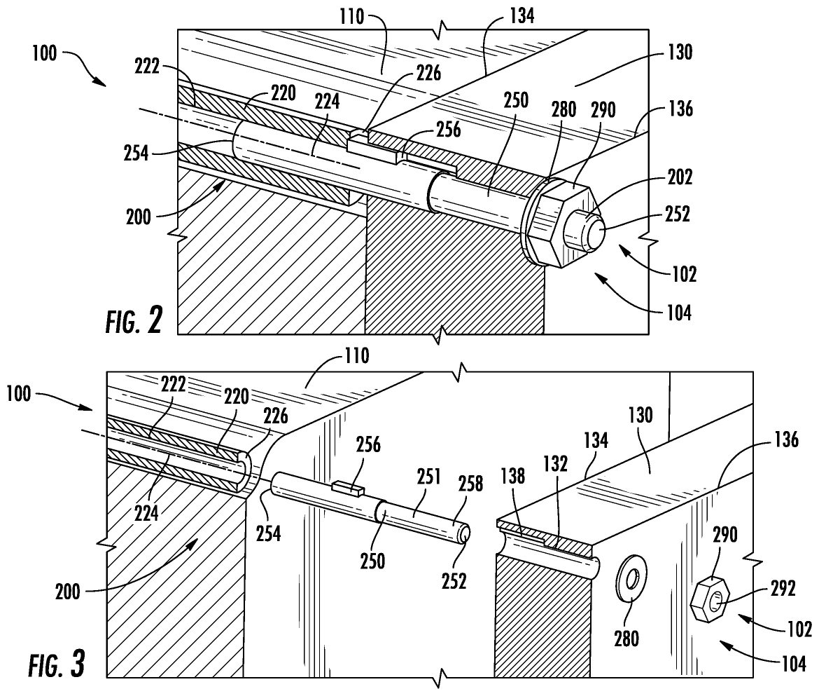

FIG. 2 is an assembled cut-away view of the compliant assembly of FIG. 1, according to an embodiment of the present disclosure;

FIG. 3 is an exploded view of the compliant assembly of FIG. 1, according to an embodiment of the present disclosure;

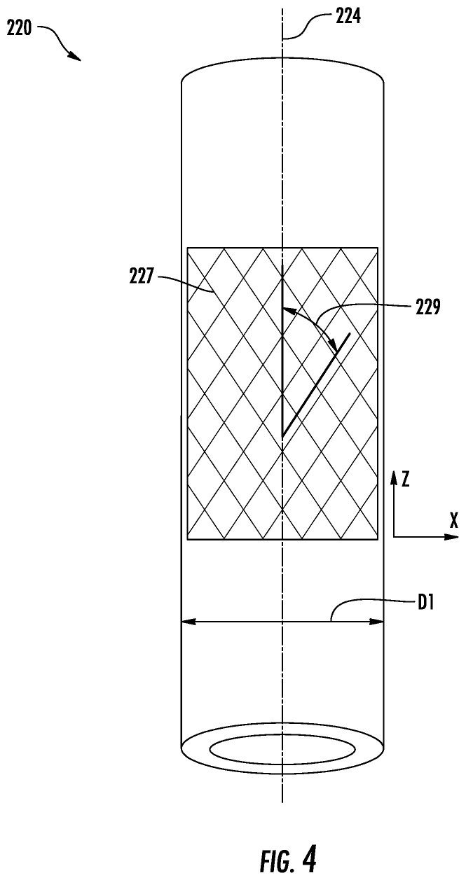

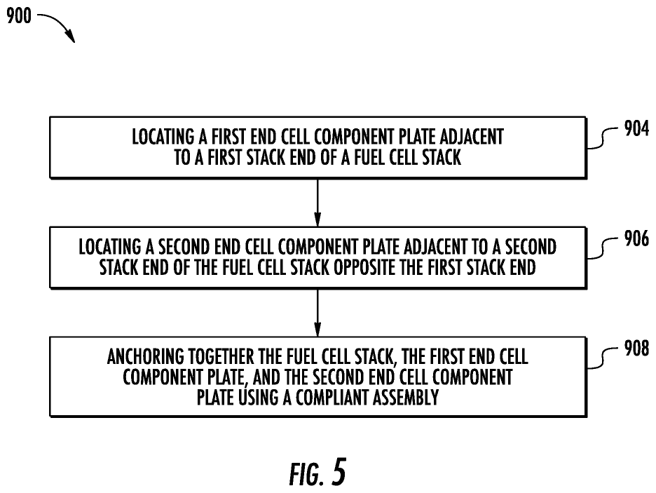

FIG. 4 is a view of the braiding of a rod of the compliant assembly of FIGS. 1-3, according to an embodiment of the present disclosure; and

FIG. 5 is a flowchart illustrating a method of manufacturing the fuel cell assembly, according to an embodiment of the present disclosure.

### DETAILED DESCRIPTION

A detailed description of one or more embodiments of the disclosed apparatus and method are presented herein by way of exemplification and not limitation with reference to the Figures.

Fuel cell stacks produce electricity from reducing fluid and process oxidant reactant streams, and comprises a plurality of fuel cell component plates stacked adjacent each other to form a reaction portion of the fuel cell stack. The plurality of fuel cell component plates include a first end plate at a first end of the stack of fuel cell component plates, and a second end plate at an opposed second end of the stack of fuel cell component plates. The fuel cell stack is compressed between the first end plate and the second end plate. Conventionally, the first end plate, the second end plate, and the fuel cell stack located between the first end plate and the second end plate are anchored together by tie rods and associated springs, which allow for expansion and contraction of the fuel cell stack. The tie rods and springs are typically composed of a metallic material that is conductive and have to be electrically separated from the fuel cell stack to avoid short circuiting the fuel cell stack.

Further, temperature changes and moisture content in the fuel cell stack may cause expansion and contraction of the fuel cells stack. The metal tie rods typically have high stiffness and there is a difference in the expansion rate of the tie rods and the expansion rate of the fuel cell stacks. The springs are conventionally used to allow for further expansion and contraction of the fuel cell stack than would be allowable by the metal tie rod alone. Additionally, due to creep in the polymeric cell materials and seals, the load decreases over time and the springs may be used to maintain the load. The springs are typically placed outside of the fuel cell stack. More specifically, the springs are typically placed outside of the first end plate and outside the second end plate. The location of the springs typically adds a great deal of space to the overall fuel cell assembly. Further, the tie rods and springs are also typically heavy and add a great deal of weight to the overall fuel cell assembly. The embodiments disclosed herein seek to provide compliant tie rods that are both light-weight and non-conductive to compress the fuel cell together while allowing for expansion and contraction of the fuel cell.

Referring now to FIG. 1, a fuel cell assembly 100 with a compliant assembly 200 is illustrated, in accordance with an embodiment of the present disclosure. As shown in FIG. 1 the fuel cell assembly 100 is composed of a fuel cell stack 110, a first end plate 130, a second end plate 140, and a compliant assembly 200.

The fuel cell stack 110 may be composed of a plurality of fuel cell component plates 116 and catalyst coated membranes 118 interposed between the fuel cell component plates 116. The component plates 116 and catalyst coated membranes 118 are separated by porous carbon paper (not shown) that facilitates transport of oxidant and reductant gases. The fuel cell component plates 116 may be composed of graphite. The membranes 118 may be composed of a polymer material with ion-exchange groups. Catalyst layers contain platinum catalyst supported by carbon that are coated with ionomer to enable proton transport. It is understood that while a particular fuel cell stack 110 has been described herein, the embodiments disclosed herein may be applicable to any fuel cell stack known to one of skill in the art.

The fuel cell stack 110 is interposed between the first end cell component plate 130 at a first stack end 112 of the fuel cell stack 110 and the second end plate 140 at a second stack end 114 of the fuel cell stack 110. The second stack end 114 of the fuel cell stack 110 being located opposite the first stack end 112. The first end plate 130 and the second end plate 140 are composed of an insulating or conductive material.

The compliant assembly 200 extending from the first end plate 130 and the second end plate 140. The compliant assembly 200 is configured to anchor together the fuel cell stack 110, the first end plate 130, and the second end plate 140. The compliant assembly 200 includes a rod 220 that extends from a first rod end 226 to a second rod end 228 located opposite the first rod end 226. The first rod end 226 is located proximate or at the first stack end 112 and the second rod end 228 is located proximate or at the second stack end 114. The rod 220 is configured to expand with expansion of the fuel cell stack 110 and contract with contraction of the fuel cell stack 110, as discussed further herein. The rod 220 may be composed of a compliant material that allows for the rod 220 is to expand with expansion of the fuel cell stack 110 and contract with contraction of the fuel cell stack 110, as also discussed further herein.

The compliant assembly 200 extends from a first end 202 to a second end 204 located opposite the first end 202. The first end 202 being located proximate or at the first end plate 130 and the second end 204 being located proximate or at the second end plate 140. The compliant assembly 200 is configured to secure the first end plate 130, the second end plate 140, and the fuel cell stack 110 together with the fuel cell stack 110 interposed between the first end plate 130 and the second end plate 140. The compliant assembly 200 may compress the first end plate 130 and the second end plate 140 together into the fuel cell stack 110. The compression by the compliant assembly 200 secures the fuel cell stack 110 between the first end plate 130 and the second end plate 140. The compliant assembly 200 is configured to provide a constant compression force on the fuel stack 110, the first end plate 130, and the second end plate 140

The fuel cell assembly 100 may be rectangular in shape having square ends 102 as illustrated in FIG. 1. While the fuel cell assembly 100 is illustrated as being rectangular in shape with square ends 102, the embodiments disclosed herein are also applicable to fuel cell assemblies of different shapes, sizes, and number of corners. The square ends 102 of the fuel cell assembly 100 have four corners 104. A compliant assembly 200 may be located at or proximate each of the four corners 104. Therefore, the fuel cell assembly 100 may include four compliant assemblies 200. Based on the shape of the ends of the fuel cell assembly 100 (e.g., number of corners), fewer or more compliant assemblies 200 may be included and two compliant assemblies 200 may be used as a minimum.

Referring now to FIGS. 2 and 3, with continued reference to FIG. 1, an enlarged cutaway view of the compliant assembly 200 at one corner 104 of the fuel cell assembly 100 is illustrated, in accordance with an embodiment of the present disclosure. FIG. 2 is an assembled cut-away view of the compliant assembly 200 and FIG. 3 is an exploded view of the compliant assembly 200. It is understood that while the first end plate 130 is illustrated and described in relation to FIGS. 2 and 3, the embodiments disclosed herein are equally applicable to the second end plate 140. Further, it is understood that while the first end 202 is illustrated and described in relation to FIGS. 2 and 3, the embodiments disclosed herein are equally applicable to the second end plate 140.

The compliant assembly 200 includes a rod 220, a connector body 250, a washer 280, and a nut 290. The rod 220 may be cylindrical in shape, tubular in shape, or have any polygon shape, as illustrated in FIGS. 2 and 3. The rod 220 can be hollow or solid. The rod 220 includes a passageway 222 formed therein. The passageway 222 may extend completely through the rod 220 from a first rod end 226 to a second rod end 228. The passageway 222 may not extend completely through the rod 220 from a first rod end 226 to a second rod end 228 but rather may have a limited depth from the first rod end the 226 and the second rod end 228. In other words, the passageway 222 may extend only partially into the rod 220 from the first rod end 226 and/or the second rod end 228. The passageway 222 may extend along a central longitudinal axis 224.

The first end plate 130 includes a through-passage 132 formed therein. The through-passage 132 extending completely through the first end plate 130, as illustrated in FIGS. 2 and 3. The first end plate 130 includes an inward side 134 and an outward side 136 located opposite the inward side 134. The through-passage 132 extends from the inward side 134 to the outward side 136. The through-passage 132 may be predominately cylindrical in shape with the exception of a slot 138. The through-passage 132 may include one or more slots 138. Multiple slots 138 may form a spline or any other interlocking shape to prevent the connector body 250 from rotating, as discussed further herein.

The connector body 250 includes a first connector end 252, a second connector end 254 located opposite of the first connector end 252, a key or flange 256 located between the first connector end 252 and the second connector end 254, and external threads 258 located at or proximate the first connector end 252. The nut 290 is located proximate the outward side 136 of the first end plate 130. The nut 290 includes internal threads 292 configured to interlock with the external threads 258 of the rod 220.

The connector body 250 is predominately cylindrical in shape with the exception of the flange 256. The flange 256 extends away from the cylindrical portion 251 of the connector body 250.

The slot 138 of the through-passage 132 is configured to interlock with the flange 256 when the connector body 250 is inserted into the through-passage 132. The flange 256 may be considered an anti-rotation feature that is configured to prevent rotation of the connector body 250 relative to the first end plate 130. The flange 256 or anti-rotation feature may have any shape or geometry. The anti-rotation feature may be configured to prevent rotation of the connector body 250 relative to the first end plate 130 by interlocking with the first end plate 130.

The flange 256 is configured to prevent rotation of the connector body 250 by interlocking with the slot 138. The slot 138 may be located at the inward side 134 and extends into the first end plate 130. The slot 138 extends radially outward from the through-passage 132 and into the first end plate 130.

The connector body 250 may be secured to the rod 220. The connector body 250 may be attached to the passageway 222 at or proximate the first connector end 252. The connector body 250 may be bonded to the passageway 222 at or proximate the second connector end 254 via an adhesive or an interlocking threads. The connector body 250 may be composed of a metallic material.

The first end plate 130 may slide onto the connector body 250 such that the first connector end 252 of the connector body 250 is inserted through the through-passage 132. Then the washer 280 is inserted onto the first connector end 252 and the nut 290 is tightened onto the first connector end 252. The flange 256 may interlock with the slot 138 prevents the connector body 250 from rotating when the nut 290 it tightened. The nut 290 serves as an anchoring mechanism to anchor the first end plate 130 to the fuel cell stack 110. Alternatively, another anchoring mechanism may be used that allows for the removal of the nut 290, the flange 256, and the slot 138 from the compliant assembly 200. For example, the first end plate 130 may be anchored to the fuel cell stack 110 using a locking pin slide through a hole in the connector body 250 proximate the first connector end 252. Alternatively, a crimped bushing may be utilized in place of the locking pin and hole combination.

Referring now to FIG. 4, with continued reference to FIGS. 1-3, a schematic view of the braiding of the rod 220 is illustrated, in accordance with an embodiment of the present disclosure. The rod 220 is composed of a composite material that comprise a plurality of composite fibers 227. The composite fibers 227 may be impregnated by a resin or other material to fill the gaps between the composite fibers 227 and cured. The composite fibers 227 may be non-conductive or conductive. If the composite fibers are conductive, then the rod 220 may be coated with an insulation coating. The composite fiber 227 may be fiberglass or any other similar material known to one of skill in the art. If the composite fiber 227 is composed of carbon fiber, a thin insulation coating could be applied to an outer diameter of the rod 220. The rod 220 composition may be finetuned in order to achieve a desired axial compliance alone the central longitudinal axis 224 to allow for sufficient expansion and contraction of the rod 220 during expansion and contraction of the fuel cell stack 110. Aspects, such as, for example a braiding angle of the composite fiber 227, a diameter D1 of the rod 220, a number of plies of composite within the rod 220, and a matrix selection. The matrix selections also affects the stiffness of the rod 220. A matrix with a higher Young's modulus would make the rod 220 stiffer and a matrix with a lower Young's modulus would make the rod 220 less stiff.

FIG. 4 illustrates the directional braiding of the composite fibers 227 and the braiding angle 229. The braiding angle 229 may be an angle of the composite fibers 227 relative to the central longitudinal axis 224. The composite material may be composed of a plurality of composite fibers 227. The plurality of composite fibers 227 may have a braiding angle 229 that is non-perpendicular and non-parallel to a central longitudinal axis 224 of the rod 220.

If the composite fibers 227 are oriented parallel to the central longitudinal axis 224, then the composite fibers 227 are at maximum tensile strength and the rod 220 will have a minimum amount of axial compliance during expansion and contraction of the fuel cell stack 110. If the composite fibers 227 are oriented at a ninety-degree angle relative to the central longitudinal axis 224, then the composite fibers 227 are at minimum tensile strength and the rod 220 will have a maximum amount of axial compliance during expansion and contraction of the fuel cell stack 110. Therefore, the desired amount of axial compliance for the rod 220 may be finetuned by using a desired braiding angle 229 somewhere between about zero degrees and ninety degrees. The rod 220 may be composed of multiple different ply layers of the composite fibers 227 and each ply layer may have a different or a similar braiding angle 229 to the other ply layers in the rod 220 to achieve the overall desired stiffness of the rod 220. The ply layers may each switch between negative and positive braiding angles 229.

Referring now to FIG. 5, with continued reference to FIGS. 1-4, a flow chart of a method 900 of manufacturing a fuel cell assembly 100 is illustrated, in accordance with an embodiment of the disclosure.

At block 904, a first end plate 130 is placed or located adjacent to a first stack end 112 of a fuel cell stack 110.

At block 906, a second end plate 140 is placed or located adjacent to a second stack end 114 of the fuel cell stack 110 opposite the first stack end 112. The fuel cell stack 110 being interposed between the first end plate 130 and the second end plate 140.

At block 908, the fuel cell stack 110, the first end plate 130, and the second end plate 140 are anchored together using one or more compliant assemblies 200. The compliant assembly 200 extends from a first end 202 to a second end 204 located opposite the first end 202. The first end 202 is located proximate or at the first end plate 130 and the second end 204 being located proximate or at the second end plate 140. The compliant assembly 200 is composed of a rod 220 extending from a first rod end 226 to a second rod end 228 located opposite the first rod end 226. The first rod end 226 is located proximate or at the first stack end 112 and the second rod end 228 is located proximate or at the second stack end 114. The compliant assembly also includes a connector body 250 secured to the rod 220 at or proximate the first rod end 226 and an anchoring mechanism secured to the connector body 250. The anchoring mechanism is configured to anchor the first end plate 130 to the fuel cell stack 110.

The method 900 may also include that the connector body 250 is secured to the rod 220. The connector body 250 includes a first connector end 252 and a second connector end 254 located opposite the first connector end 252. The connector body 250 is secured to the rod 220 at or proximate the second connector end 254 of the connector body 250.

The method 900 may further include that the first end plate 130 is slid onto the connector body 250 such that the first connector end 252 of the connector body 250 is inserted through a through-passage 132 of the first end plate 130.

The method 900 may yet further include that a nut 290 is rotated onto external threads 258 of the connector body 250 located at or proximate the first connector end 252 of the connector body 250. The nut 290 includes internal threads 292 configured to interlock with the external threads 258 of the connector body 250.

The method 900 may yet also include that a flange 256 of the connector body 250 is aligned with a slot 138 of the through-passage 132 of the first end plate 130. This may occur prior to or simultaneously with sliding the first end plate 130 onto the connector body 250. The flange 256 is configured to interlock with the slot 138 to prevent rotation of the connector body 250 relative to the first end plate 130.

The method 900 may still further include that the rod 220 is formed from a composite material that comprises a plurality of composite fibers 227 having a braiding angle 229 that is non-perpendicular and non-parallel to a central longitudinal axis 224 of the rod 220.

Technical effects and benefits of the features described herein include anchoring together a fuel cell assembly using a composite rod that expands and contacts with the fuel cell stack and an anchoring mechanism operably connected to the composite rod.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fuel cell assembly, comprising:
a fuel cell stack having a first stack end and a second stack end located opposite the first stack end;
a first end plate located at the first stack end;
a second end plate located at the second stack end, the fuel cell stack being interposed between the first end plate and the second end plate;
a compliant assembly extending from a first end to a second end located opposite the first end, the first end being located proximate or at the first end plate and the second end being located proximate or at the second end plate, wherein the compliant assembly is configured to anchor together the fuel cell stack, the first end plate, and the second end plate, and
wherein the compliant assembly comprises:
a rod extending from a first rod end to a second rod end located opposite the first rod end, the first rod end being located proximate or at the first stack end and the second rod end being located proximate or at the second stack end;
a connector body secured to the rod at or proximate the first rod end; and
an anchoring mechanism secured to the connector body, the anchoring mechanism being configured to anchor the first end plate to the fuel cell stack.

2. The fuel cell assembly of claim 1, wherein the rod is configured to expand with expansion of the fuel cell stack and contract with contraction of the fuel cell stack.

3. The fuel cell assembly of claim 1, wherein the rod is composed of a compliant material that is configured to expand with expansion of the fuel cell stack and contract with contraction of the fuel cell stack.

4. The fuel cell assembly of claim 2, wherein the rod is composed of a composite material that comprises a plurality of composite fibers.

5. The fuel cell assembly of claim 4, wherein the plurality of composite fibers have a braiding angle that is non-perpendicular and non-parallel to a central longitudinal axis of the rod.

6. The fuel cell assembly of claim 1, wherein the rod has a passageway formed therein, and wherein the connector body is secured to the passageway of the rod.

7. The fuel cell assembly of claim 1, wherein the first end plate further comprises an inward side, an outward side located opposite the inward side, and a through-passage extending completely through the first end plate from the inward side to the outward side, and wherein the connector body extends through the through-passage of the first end plate.

8. The fuel cell assembly of claim 7, wherein the connector body further comprises a first connector end, a second connector end located opposite the first connector end, and external threads located at or proximate the first connector end, and
wherein the anchoring mechanism is a nut having internal threads configured to interlock with the external threads of the connector body, the nut being located proximate the outward side of the first end plate.

9. The fuel cell assembly of claim 8, wherein the connector body further comprises an anti-rotation mechanism configured to prevent rotation of the connector body relative to the first end plate.

10. The fuel cell assembly of claim 9, wherein the anti-rotation mechanism is configured to prevent rotation of the connector body relative to the first end plate by interlocking with the first end plate.

12. The fuel cell assembly of claim 10, wherein the anti-rotation mechanism is a flange extending away from the connector body, wherein the through-passage further includes a slot extending radially outward from the through-passage and into the first end plate, and wherein the flange is configured to interlock with the slot.

13. The fuel cell assembly of claim 12, wherein the slot is located at the inward side of the first end plate and extends into the first end plate.

14. The fuel cell assembly of claim 1, wherein the compliant assembly comprises:
a second connector body secured to the rod at or proximate the second rod end; and
a second anchoring mechanism secured to the second connector body, the second anchoring mechanism being configured to anchor the second end plate to the fuel cell stack.

15. A method of manufacturing a fuel cell assembly, the method comprising:
locating a first end plate adjacent to a first stack end of a fuel cell stack;
locating a second end plate adjacent to a second stack end of the fuel cell stack opposite the first stack end, the fuel cell stack being interposed between the first end plate and the second end plate;
anchoring together the fuel cell stack, the first end plate, and the second end plate using a compliant assembly, the compliant assembly extending from a first end to a second end located opposite the first end, wherein the first end is located proximate or at the first end plate and the second end being located proximate or at the second end plate, and wherein the compliant assembly comprises:
a rod extending from a first rod end to a second rod end located opposite the first rod end, the first rod end being located proximate or at the first stack end and the second rod end being located proximate or at the second stack end;
a connector body secured to the rod at or proximate the first rod end; and
an anchoring mechanism secured to the connector body, the anchoring mechanism being configured to anchor the first end plate to the fuel cell stack.

16. The method of claim 15, further comprising:
securing the connector body to the rod, the connector body comprising a first connector end and a second connector end located opposite the first connector end, wherein the connector body is secured to the rod at or proximate the second connector end of the connector body.

17. The method of claim 16, further comprising:
sliding the first end plate onto the connector body such that the first connector end of the connector body is inserted through a through-passage of the first end plate.

18. The method of claim 17, further comprising:
rotating a nut onto external threads of the connector body located at or proximate the first connector end of the connector body, the nut comprising internal threads configured to interlock with the external threads of the connector body.

19. The method of claim 17, further comprising:
aligning a flange of the connector body with a slot of the through-passage of the first end plate, the flange being configured to interlock with the slot to prevent rotation of the connector body relative to the first end plate.

20. The method of claim 16, further comprising:
forming the rod from a composite material, the composite material comprising a plurality of composite fibers having a braiding angle that is non-perpendicular and non-parallel to a central longitudinal axis of the rod.
